(19) United States
(12) Patent Application Publication
(10) Pub. No.: US 2018/0199508 A1
(43) Pub. Date: Jul. 19, 2018

(54) CUTTING ARRANGEMENT

(71) Applicant: Zürn Harvesting GmbH & Co. KG, Schöntal-Westernhausen (DE)

(72) Inventors: Matthias Mueller, Ilsfeld (DE); Rolf Zuern, Schöntal-Westernhausen (DE); Steffen Woebcke, Dresden (DE); Thomas Herlitzius, Coswig (DE); Norbert Michalke, Dresden (DE); Uwe Schuffenhauer, Werdau (DE); Marco Jung, Oberhonnefeld (DE); Sascha Otto, Racksen (DE)

(73) Assignee: Zürn Harvesting GmbH & Co. KG, Schöntal-Westernhausen (DE)

(21) Appl. No.: 15/742,175

(22) PCT Filed: Jul. 7, 2016
(86) PCT No.: PCT/EP2016/066118

§ 371 Date: Jan. 5, 2018

(30) Foreign Application Priority Data
Jul. 8, 2015 (EP) 15175795.2

(51) Int. Cl. A01D 41/14; A01D 41/127; A01D 43/077

(52) U.S. Cl. CPC A01D 41/141; A01D 41/142; A01D 43/077; A01D 41/1274

(57) ABSTRACT

A cutting unit arrangement for a harvester having a cutting unit has at least one working device relating to the processing and/or conveying of harvested crops and has a drive for the working device, wherein the drive is configured to drive the working device in accordance with harvesting operation via a rotatable drive element having a variable rotational speed. A control device of the cutting unit arrangement associated with the drive is configured to regulate the rotational speed of the drive element using a predefined desired rotational speed value.

The present invention relates to a cutting unit arrangement for a harvester, in particular for a combine harvester, having a cutting unit that has at least one working device relating to the processing and/or conveying of harvested crops and that has a drive for the working device, wherein the drive is configured to drive the working device in accordance with harvesting operation via a rotational drive element.

Cutting unit arrangements of this kind are used in the machine harvesting of agricultural crop plants such as cereals, rape or sunflowers. Cutting units for harvesters generally have a plurality of different working devices such as a rotatable reel, a cutter bar, a side cutter arrangement, an intake auger, a belt conveyor and/or an inclined conveyor. Conventionally, the drives of the working devices are mechanical and of fixed speed.

The revolution speed adapted to normal operating conditions can in particular be unfavorable under changing or difficult harvesting conditions such as on the presence of lodged grain or wet straw. An adaptation of the cutting unit is only possible for an operator of the harvester with comparatively great difficulties in such situations. For example, a manual switching of a transmission, a changing of chain wheels or the like could take place. This is time-consuming and inconvenient, however. In addition, an adaptation is at best possible in rough stages in this manner. Ultimately, therefore, the technically available power is frequently not fully utilized in harvesters having conventional cutting units.

It is an object of the invention to enable a more effective operation of harvesters, in particular under difficult harvesting conditions.

The object is satisfied by a cutting unit arrangement having the features of claim 1.

In accordance with the invention, the revolution speed of the drive element is variable, with a control device of the cutting unit arrangement associated with the drive being configured to regulate the revolution speed of the drive element using a predefined desired revolution speed value. The revolution speed of the drive element, and thus the movement of the driving device in accordance with harvesting operation, can thus be adapted in a faster, simpler and more flexible manner to different harvesting conditions. For example, the cutting speed of the cutting blade arrangement or the conveying speed of a belt conveyor can be adapted to the consistency of the harvested crops. A cutting unit regulated in this manner enables a particularly efficient operation of the associated harvester.

Further developments of the invention can be seen from the dependent claims, from the description and from the enclosed drawing.

The control device is preferably configured to regulate the revolution speed of the drive element continuously and/or steplessly. This can take place by a corresponding control with an electric or hydraulic drive. With a mechanical drive, a continuous and/or stepless regulation can be effected, for example, by a stepless transmission. It is possible by a continuous tracking of the revolution speed during the operation of the cutting unit arrangement always to provide an ideally adapted operating movement of the respective working device. A stepless regulation of the revolution speed of the drive enables a substantially more exact adaptation of the operating movement of the drive device than is, for example, possible with a splitter transmission.

The working device can be a cutting blade arrangement for reaping the harvested crops, a belt conveyor for conveying the harvested crops or an intake auger for supplying the harvested crops to an intake shaft.

The cutting unit preferably has a plurality of working devices, including respective drives, relating to the processing and/or conveying of the harvested crops, wherein the control device is connected to each of the drives and is configured to regulate the speeds of the drive elements of the drives using respective desired revolution speed values. In other words, it is preferred not only to adapt a single working device such as the reel of a cutting unit to the current operating condition, but also a plurality of working devices, particularly preferably all the working devices, present at the cutting unit and rotatingly driven. It is in particular possible by the mutually independent regulations of the individual drives to ideally coordinate the different functional components of a cutting unit with one another. This enables a particularly productive operation of the associated harvester.

The or each drive is preferably designed as an electric drive, in particular as an electric motor. The revolution speed of an electric drive can be regulated in a particularly simple manner via the control or the power supply. No complex and expensive transmission components are in particular required for the regulation of an electric drive. Such transmission components can, however, nevertheless be present if required. A further advantage of an electric drive comprises the actual revolution speed and/or the actual torque of the respective drive element being able to be easily determined by a current measurement and/or a voltage measurement as required. Complex and/or expensive sensors and the like are not required for this purpose. With an electric motor as the drive, the rotatable drive element is generally formed by the associated motor shaft.

In accordance with an embodiment of the invention, the control device is configured to determine the desired revolution speed value or all the desired revolution speed values automatically, in particular without operator intervention, using at least one input signal. The automatic determination of the desired revolution speed value can take place by a suitable algorithm, for example. The input signal can, for example be a sensor input. Alternatively, the measured current and/or the measured voltage of an electric drive could also be made use of as the input signal for determining the desired revolution speed value for this drive and/or for a different drive. A desired value specification without any operator intervention frees up the operator of the harvester from the selection, that may be difficult under certain circumstances, of a favorable value.

A specific embodiment of the invention provides that means are provided for detecting an actual revolution speed value and/or an actual torque value of the drive element and that the control device is configured to determine the desired revolution speed value in dependence on the detected actual revolution speed value and/or on the detected actual torque value. Due to the separate detection of the actual value or values, a particularly reliable adjustment of the revolution speed of the drive element to the specified desired value is possible.

A further embodiment of the invention provides that the control device is configured to carry out a plausibility check and/or to define a load-dependent servicing interval on the basis of the detected actual revolution speed value and/or on the detected actual torque value and/or to define a load-dependent servicing interval and/or that the control device is configured to increase the desired revolution speed value of the drive element as soon as an actual torque value of the respective drive element increases by a predefined threshold value. A plausibility check can serve to recognize problematic operating situations in good time. If, for example, the torque of the intake auger does not match the throughput, this can indicate a jamming of the harvested crops. Such a bottleneck can be countered by corresponding changes of the settings. Pronounced load peaks can additionally indicate defects. A load-dependent servicing interval is generally more suitable to requirements than a time-dependent servicing interval.

The control device can be configured to determine the desired revolution speed value in dependence on a travel speed of the harvester, on a kind of harvested crops or on a harvest stage. A cutting unit operation at revolution speeds reduced with respect to a cereal harvest can, for example, be provided for a rape harvesting to thus minimize spray losses. An increase in efficiency of the cutting unit is also possible in that the speed of the cutting blade arrangement is selected the higher, the higher the current travel speed of the harvester is.

A further embodiment of the invention provides that the control device is configured to predefine a desired revolution speed for the drive element of a belt conveyor drive of the cutting unit that is the higher, the higher an actual revolution speed value of the drive element of an intake auger of the cutting unit is. A particularly uniform harvest flow can be ensured in the cutting unit in this manner. Alternatively or additionally, the control device can be configured to determine the desired revolution speed value such that an actual torque value of the drive element remains beneath a predefined torque threshold value. This allows a torque limitation for overload protection. The drive system of the cutting unit can thus be spared overall.

A further embodiment of the invention provides that the control device is configured to set the desired revolution speed value to a minimal value beneath a normal operation range on a presence of a passive state criterion and/or that the control device is configured to reverse the sign of the desired revolution speed value on a presence of a crop bottleneck criterion.

It is, for example, possible in this manner only to start a possible harvest area measurement on a presence of a demonstrable torque at the blade drive. In addition, unwanted blank measurements with a lowered cutting unit with running drives can thus be prevented. It can specifically be favorable to slow down or even to completely stop the drives at the headland. Specifically, a stopping of the cutter bar and of the intake auger could be provided at the headland with a slowly still running reel and equally with a slowly still running intake auger. It is possible by reversing the desired revolution speed to temporarily operate a conveying device such as the intake auger, a belt conveyor and/or the inclined conveyor backward and so to automatically eliminate any harvested crop bottleneck present. It is also possible in a simple manner by means of a cutting unit arrangement in accordance with the invention to generate a signal independent of the throughput in the region of the cutting unit. This signal dependent on the throughput can be used in a variety of manners for further control work.

The control device can be configured to regulate the revolution speed of the drive element using a desired revolution speed value received from an external operating device. The operating device can, for example, be located in the driver's cabin of the harvester. The driver of the harvester can thus regulate the revolution speed of the corresponding drive fast and comfortably from the driver's cabin.

The invention also relates to a cutting unit arrangement for a harvester, in particular for a combine harvester, having a plurality of working devices relating to the processing and/or conveying of harvested crops such as a reel, a cutting blade arrangement, an intake auger, an inclined conveyor, and respective drives for the working devices.

All the drives are designed as electric drives in accordance with the invention. Such a purely electrically operated cutting unit can be controlled particularly simply and exactly.

The invention further relates to a method of operating a harvester, in particular a combine harvester, that comprises a cutting unit that has at least one working device relating to the processing and/or conveying of harvested crops and has a drive for the working device, wherein the drive is configured to drive the working device element in accordance with harvesting operation via a rotatable drive.

In accordance with the invention, the revolution speed of the drive element is regulated using a predefined desired revolution speed value. An ideal adaptation of the cutting unit operation to different harvesting conditions is possible in this manner.

The invention will be described in the following by way of example with reference to the drawing.

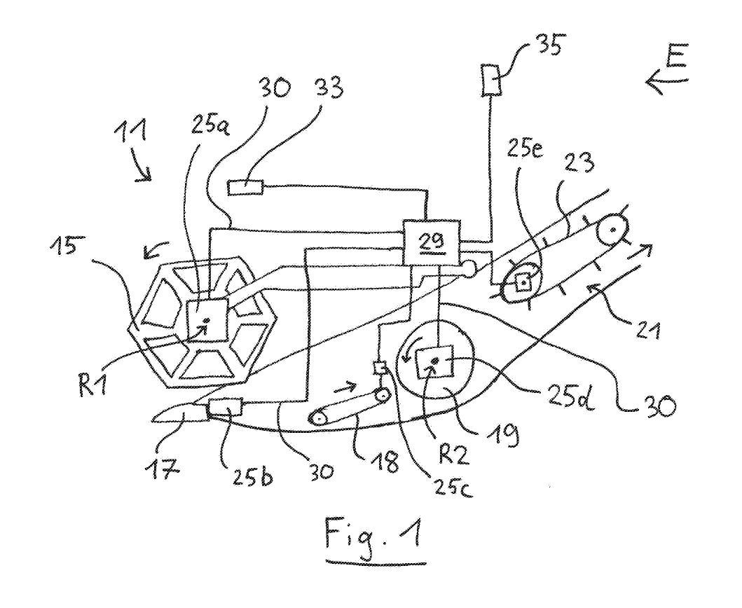

FIG. 1 is a simplified, partly sectioned side view of a cutting unit arrangement in accordance with the invention.

A cutting unit 11 is shown for a combine harvester which is not shown and which is configured to reap crop plants such as rye, wheat, barley or rape along a harvesting direction E and subsequently to subject them to a threshing procedure is shown in FIG. 1. The cutting unit 11 comprises in a manner known per se a reel 15 which is rotatably driven about a first rotational axis R1 extending transversely to the harvesting direction E and which comprises a cutting blade arrangement arranged beneath the reel 15 in the form of a cutter bar 17 arranged transversely to the harvesting direction E. The cutter bar 17 can be supplemented by side cutters, which is not shown in FIG. 1, however. A belt conveyor 18 and an intake auger 19 serve to convey the reaped harvested crops into an intake shaft 21. The intake auger 19 is rotatably driven about a second axis of rotation R2 extending in parallel with the first axis of rotation R1. The conveying of the harvested crops takes place by means of an inclined conveyor 23 within the intake shaft 21. Said inclined conveyor provides the conveying of the harvested crops into the interior of the combine harvester and to the corresponding threshing unit.

The reel 15, the cutter bar 17, the belt conveyor 18, the intake auger 19, and the inclined conveyor 23 have respective drives 25a-e that are only shown in schematic form and that serve to set said working devices 17, 18, 29, 23 into a movement in accordance with harvesting operation via rotatable drive shafts (not shown) and via optionally present transmission arrangements. In the embodiment shown, the drives 25a-e are designed as purely electric drives and the rotatable drive shafts are formed by the motor shafts of these electric drives.

An electronic control device 29 is connected to the drives 25a-e via corresponding signal and control lines 30. The electronic control device 29 is able to regulate the revolution speeds of the respective drive shafts to respective desired revolution speed values by a suitable control of the drives 25a-e. Provision is also made that the electronic control device 29 receives current values and voltage values from all the drives 25a-e via the signal and control lines 30 and determines the actual revolution speed values and the actual torque values of the drive shafts of all the drives 25a-e. The electronic control device 29 furthermore receives the output signal of a sensor 33 which can, for example, be an optoelectronic sensor for determining the crop height of the harvested crops prior to the reaping. Depending on the application, further sensors such as a temperature sensor or a moisture sensor can be connected to the control device 29. Finally, the electronic control device 29 also receives the output signal of an operating device 35 that is arranged in the driver's cabin of the combine harvester. In the embodiment shown, the electronic control device 29 is directly integrated into the cutting unit 11. Alternatively, the electronic control device 29 could also be arranged at a different point of the combine harvester and can form a corresponding cutting unit arrangement together with the cutting unit 11.

The electronic control device 29 receives the signals of the sensor 33 and of the operating device 34 as well as the actual current values and voltage values of the drives 25a-e during the operation of the combine harvester. A respective desired revolution speed value for the drive shaft is determined using an algorithm stored in the control device 29 while taking account of the received signals for each drive 25a-e. The control device 29 then regulates the revolution speed of each drive element of the derives 25a-e continuously and steplessly. Where required, the determination of the desired revolution speed value for individual drives or all drives 25a-e can be limited to a direct takeover of a desired value from the operating device 35.

It is understood that the algorithm for determining the individual desired revolution speed values while taking account of the received signals can be simple or complex depending on the application. In the determination of the desired revolution speed values, the control device 29 can in particular take account of the actual revolution speed values and the actual torque values of the remaining drives 25a-e, the travel speed of the combine harvester, the kind of harvested crops, for example “rape” or cereal” specified by the driver via the operating device 35, or the determined harvest stage. The regulation preferably takes place with the specification that a flow of the harvested crops through the total cutting unit 11 that is as uniform as possible is ensured. On an abrupt torque increase at the drive shaft of a drive 25c-e that is associated with the belt conveyor 18, the intake auger 19, or the inclined conveyor 23, a harvested crop bottleneck can generally be assumed. Such a bottleneck can be reported to the driver of the combine harvester in the cabin. In addition, the belt conveyor 18, the intake auger 19 and/or the inclined conveyor 23 can be temporarily operated backward to release the harvested crop bottleneck. If the combine harvester is in the headland, some or all of the drives 25a-e can be throttled or switched off in order hereby to save energy and to avoid a falsification of the harvest area measurement. In addition, the control device 29 can provide a torque limitation of the drives 25a-e in order thus to avoid an overload of the corresponding components.

The invention overall permits an adaptation of the operating movements of all the working devices of a cutting unit 11 such as a reel 15, a belt conveyor 18, an intake auger 19, and an inclined conveyor 23 and thus provides a particularly high productivity of harvesters such as combine harvesters.

### REFERENCE NUMERAL LIST

11 cutting unit
15 reel
17 cutter bar
18 belt conveyor
19 intake auger
21 intake shaft
23 inclined conveyor
25a-e drive
29 control device
30 signal and control line
33 sensor
35 operating device
E harvesting device
R1 axis of rotation of the reel
R2 axis of rotation of the intake auger

1. A cutting unit arrangement for a harvester, having a cutting unit with the cutting unit having at least one working device relating to at least one of the processing and conveying of harvested crops and the cutting unit having a drive for the working device, wherein the drive is configured to drive the working device in accordance with harvesting operation via a rotatable drive element,
wherein the revolution speed of the drive element is variable, with a control device of the cutting unit arrangement associated with the drive being configured to regulate the revolution speed of the drive element using a predefined desired revolution speed value.

2. The cutting unit arrangement in accordance with claim 1,
wherein the control device is configured to regulate the revolution speed of the drive element continuously and/or steplessly.

3. The cutting unit arrangement in accordance with claim 1,
wherein the working device is one of a cutting blade arrangement for reaping the harvested crops, a belt conveyor for conveying the harvested crops and an intake auger for supplying the harvested crops to an intake shaft.

4. The cutting unit arrangement in accordance with claim 1,
wherein the cutting unit has a plurality of working devices, including respective drives, relating to the processing and/or conveying of the harvested crops, with the plurality of working devices each including respective drives, with the control device being connected to each of the drives and being configured to regulate the revolution speeds of the drive elements of the drives using respective desired revolution speed values.

5. The cutting unit arrangement in accordance with claim 1,
wherein the drive is designed as an electric drive.

6. The cutting unit arrangement in accordance with claim 1,
wherein the control device is configured to determine the desired revolution speed value or all the desired revolution speed values automatically, in particular without operator intervention, using at least one input signal.

7. The cutting unit arrangement in accordance with claim 6,
wherein means are provided for detecting an actual revolution speed value and/or an actual torque value of the drive element; and wherein the control device is configured to determine the desired revolution speed value in dependence on the detected actual revolution speed value and/or on the detected actual torque value.

8. The cutting unit arrangement in accordance with claim 7,
wherein the control device is configured to perform at least one of
a) performing a plausibility check and/or defining a load-dependent servicing interval on the basis of the detected actual revolution speed value and/or on the detected actual torque value; and
b) to increase the desired revolution speed value of the drive element as soon as an actual torque value of the respective drive element increases by a predefined threshold value.

9. The cutting unit arrangement in accordance with claim 6,
wherein the control device is configured to determine the desired revolution speed value in dependence on a travel speed of the harvester, on a kind of harvested crops, or on a harvest stage.

10. The cutting unit arrangement in accordance with claim 6,
wherein the control device is configured to predefine a desired revolution speed value for the drive element of a belt conveyor drive of the cutting unit that is the higher, the higher an actual revolution speed value of the drive element of an intake auger of the cutting unit is; and/or in that
the control device is configured to determine the desired revolution speed value such that an actual torque value of the drive element remains beneath a predefined torque threshold value.

11. The cutting unit arrangement in accordance with claim 6,
wherein the control device is configured to set the desired revolution speed value to a minimal value beneath a normal operating range on a presence of a state of rest criterion; and/or in that
the control device is configured to reverse the sign of the desired revolution speed value on a presence of a harvest bottleneck criterion.

12. The cutting unit arrangement in accordance with claim 1,
wherein the control device is configured to regulate the revolution speed of the drive element using a desired revolution speed value received from an external operating device.

13. A cutting unit arrangement for a harvester, the cutting unit arrangement having a plurality of working devices relating to the processing and/or conveying of harvested crops, and respective drives for the working devices, in particular in accordance with claim 1,
wherein all the drives are designed as electric drives.

14. A method of operating a harvester comprising a cutting unit that has at least one working device relating to the processing and/or conveying of harvested crops and that has a drive for the working device, wherein the drive is configured to drive the working device in accordance with harvesting operation via a rotatable drive element,
wherein the revolution speed of the drive element is regulated with reference to a predefined desired revolution speed value.
